(19) United States
(12) Patent Application Publication
(10) Pub. No.: US 2007/0136737 A1
(43) Pub. Date: Jun. 14, 2007

(54) Metal-polymer composite hub and small form factor optical disk for information storage including the same

(76) Inventors: Ho Jun Ryu, Seoul (KR); Yong Goo Yoo, Daejeon-city (KR); Woo Seok Cheong, Daejeon-city (KR); Eun Kyoung Kim, Daejeon-city (KR); Mun Cheol Paek, Daejeon-city (KR); Kwang Yong Kang, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/483,949

(22) Filed: Jul. 10, 2006

(30) Foreign Application Priority Data
Dec. 8, 2005 (KR) 10-2005-0120167
Mar. 28, 2006 (KR) 10-2006-0027973

(51) Int. Cl. G11B 7/24

(52) U.S. Cl. 720/721; 720/722

(57) ABSTRACT

Provided are a hub for chucking an optical disk to a disk table of a recording/reproducing apparatus using a magnetic attraction force, and a small form factor optical disk for information storage including the hub. The hub is made of a magnetic metal-polymer composite material. The optical disk includes: a disk plate having a central through-hole and a recess, lower than an edge, formed around the through-hole; and a hub made of a magnetic metal-polymer composite material and inserted into the through-hole to be coupled to the disk plate.

### CROSS-REFERENCE TO RELATED PATENT APPLICATION

This application claims the benefit of Korean Patent Application Nos. 10-2005-0120167 and 10-2006-0027973, filed on Dec. 8, 2005 and Mar. 28, 2006, respectively, in the Korean Intellectual Property Office, the disclosures of which are incorporated herein in entirety by reference.

### BACKGROUND OF THE INVENTION

1. Field of the Invention

The present invention relates to a hub and an optical disk including the same, and more particularly, to a hub that can chuck an optical disk on a disk table of a recording/reproducing apparatus using a magnetic attraction force and a small form factor optical disk for information storage including the hub.

2. Description of the Related Art

In general, information is recorded, stored, and reproduced on optical disks using a laser beam. High-density optical disks, such as CD, CD-R, CD-RW, and DVD, have a diameter of 120 mm and a storage capacity between 700 Mbyte and 4.7 Gbyte. Such high density optical disks have been realized by a reduction in a spot of a laser beam used for recording and reproducing information, a reduction in a track pitch, and a use of a short wavelength laser.

However, small form factor optical disks having a diameter of 30 mm or less have different structures from existing optical disks. In particular, the small form factor optical disks are generally mounted around hubs to minimize vibrations generated when the optical disks rotate at high speed. Such hubs are generally made of a magnetic material. A hub attached to a small form factor optical disk is magnetically chucked due to a magnetic force of a permanent magnet disposed on a spindle motor such that the small optical disk is mounted on the spindle motor.

Conventionally, the hub for the small optical disk is made of a magnetic metal to react to the magnetic force. The conventional optical disk including the hub has a central hole into which the hub is inserted, and the hub has an insertion hole to be mounted on the spindle motor of a disk table. The permanent magnet is installed on the spindle motor of the disk table to chuck the optical disk, and a rotating shaft protrudes from a central portion of the spindle motor. Accordingly, the optical disk is mounted on the spindle motor due to a magnetic attraction force generated between the metal hub and the permanent magnet installed on the spindle motor.

However, the conventional optical disk including the hub has a drawback in that since a central portion of the hub is higher than a surface of a disk plate, it is difficult to reduce the total thickness of the conventional optical disk and realize a small optical disk drive.

Moreover, since the hub is made of only a metal, manufacturing costs are high, and manufacturing processes are complex because of an additional coating process for corrosion protection. Also, multi-stepped complex processes including die-casting should be performed to achieve high processability, which are main factors in increasing costs.

### SUMMARY OF THE INVENTION

The present invention provides a hub which can be simply manufactured at a low cost and can be stably chucked on a spindle motor of a disk table while being attached to an optical disk.

The present invention also provides a small form factor optical disk including a hub which can realize a small form factor information storage device by reducing the thickness of its central portion to a level not more than the thickness of a disk plate.

According to an aspect of the present invention, there is provided a hub for an optical disk, the hub being made of a magnetic metal-polymer composite material.

The magnetic metal-polymer composite material may be formed by mixing the magnetic metal with the polymer at a ratio of 3:7 to 5:5. The magnetic metal may be an iron-based soft magnetic material or nickel. The polymer may be a curable resin.

The hub may comprise: a disk-shaped upper hub having a first radial length; and a lower hub integrally extending from the upper hub and having a second radial length less than the first radial length, wherein a central hole passes through both the upper hub and the lower hub.

According to another aspect of the present invention, there is provided an optical disk including a hub, the optical disk comprising: a disk plate having a central through-hole and a recess, lower than an edge, formed around the through-hole; and a hub made of a magnetic metal-polymer composite material and inserted into the through-hole to be coupled to the disk plate.

The hub may comprise: a disk-shaped upper hub having a first radial length; a lower hub integrally extending from the upper hub and having a second radial length less than the first radial length, with a central hole passing through both the upper hub and the lower hub, wherein, when the hub is inserted into the through-hole of the disk plate to be coupled to the disk plate, the upper hub is mounted in the recess.

The hub may be coupled to the disk, a top surface of the upper hub and a first surface of the disk are aligned.

The optical disk may further comprise a protective layer covering a second surface of the disk plate opposite to the first surface of the disk plate, wherein the total thickness of the hub is equal to the sum of the thickness of the disk plate and the thickness of the protective layer.

The hub can be simply manufactured using a typical resin injection process to have a good chucking performance. Since the hub is made of a metal-polymer composite material not to be affected by corrosion, costs for manufacturing the small form factor optical disk can be reduced. Also, since the hub has a thickness similar to the thickness of the disk plate so that there is no protrusion from the disk plate when the hub is attached to the small form factor optical disk, the total thickness of the small form factor optical disk can be reduced.

### BRIEF DESCRIPTION OF THE DRAWINGS

The above and other features and advantages of the present invention will become more apparent by describing in detail exemplary embodiments thereof with reference to the attached drawings in which:

FIG. 1 is a perspective view of a hub for an optical disk according to an embodiment of the present invention;

FIG. 2 is a cross-sectional view taken along line II-II′ of FIG. 1; and

FIG. 3 is a cross-sectional view of an optical disk including a hub according to an embodiment of the present invention.

### DETAILED DESCRIPTION OF THE INVENTION

The present invention will now be described more fully with reference to the accompanying drawings, in which exemplary embodiments of the invention are shown.

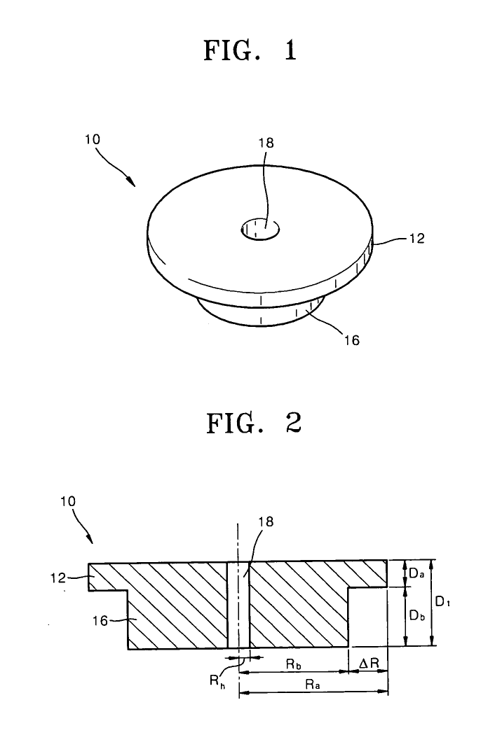

FIG. 1 is a perspective view of a hub 10 for an optical disk according to an embodiment of the present invention. FIG. 2 is a cross-sectional view taken along line II-II′ of FIG. 1.

Referring to FIGS. 1 and 2 the hub 10 is made of a magnetic metal-polymer composite material. The magnetic metal of the hub 10 may be an iron-based soft magnetic material such as pure iron, ferrite, permalloy, or sendust. Alternatively, the magnetic metal of the hub 10 may be nickel attracted to a magnet. The polymer of the hub 10 may be a curable resin. The polymer of the hub 10 may be the same as the material of a disk plate, for example, polycarbonate.

The hub 10 may be manufactured by mixing magnetic metal powder and polymer powder at a ratio of 3:7 to 5:5 and processing the mixture into a predetermined shape using an injection process. The injection process may be performed under the same conditions as those for a typical resin injection process.

The hub 10 includes a disk-shaped upper hub 12, and a lower hub 16 integrally formed with the upper hub 12. When the hub 10 is inserted into the disk plate, the upper hub 12 is exposed to the outside and the lower hub 16 is inserted into a central hole of the disk plate not to be exposed to the outside. To easily mount and fix the hub 10 to the disk plate, the radial lengths of the upper hub 12 and the lower hub 16 are different from each other by a length ΔR. Preferably, the radial length of the upper hub 12 may be greater than the radial length of the lower hub 16.

The total thickness Dₜ of the hub 10 may be the same as the thickness of the disk plate to which the hub 10 is to be coupled. For example, the total thickness Dₜ of the hub 10 may range from approximately 0.3 to 3.0 mm according to the thickness of the disk plate. The maximum diameter of the hub 10 may range from approximately 5 to 30 mm according to the size of the disk plate. Preferably, the maximum diameter of the hub 10 may be in the range of 20 to 40% of the diameter of the disk plate. The diameter of the lower hub 16 may be in the range of approximately 50 to 90% of the diameter of the upper hub 12. The radius Rₐ of the upper hub 12 corresponds to the size of a permanent magnet disposed on a spindle motor of an information storage device on which the disk plate is to be mounted, such that the upper hub 12 can be firmly chucked on the spindle motor. For example, the radius Rₐof the upper hub 12 may be approximately 4 mm, and the radius R_{b} of the lower hub 16 may be approximately 3 mm.

The thickness Dₐ of the upper hub 12 is less than the thickness D_{b} of the lower hub 16. The thickness Dₐ of the upper hub 12 may be in the range of approximately 20 to 50% of the total thickness Dₜ of the hub 10. The lower hub 16 downwardly extends from a central portion of the upper hub 12.

A central hole 18 of the hub 10 passes through both the upper hub 12 and the lower hub 16. When the hub 10 attached to the optical disk is loaded on a disk table of the information storage device, a spindle motor shaft of the information storage device is inserted into the central hole 18. In this state, the small form factor optical disk rotates at high speed about the central hole 18. The radius Rₕ of the central hole 18 may range from approximately 0.25 to 1.25 mm. For example, the radius Rₕ of the central hole 18 may be approximately 0.75 mm. When the small form factor optical disk including the hub 10 is chucked on the spindle motor of the information storage device, an upward protrusion of the spindle motor is inserted into the central hole 18, such that vibrations generated when the small form factor optical disk mounted on the disk table rotates at high speed can be reduced.

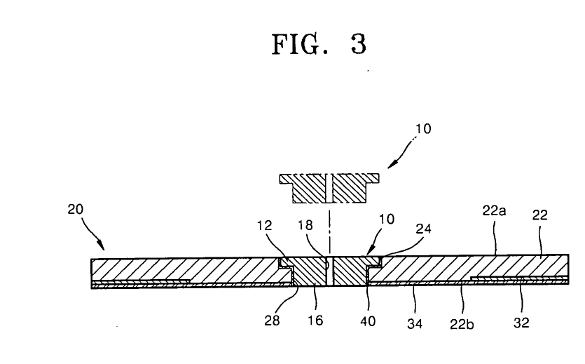

FIG. 3 is a cross-sectional view of an optical disk 20 including a hub according to an embodiment of the present invention.

Referring to FIG. 3, the optical disk 20 includes a disk plate 22 having a central through-hole 28. The disk plate 22 may be made of polycarbonate. A circular recess 24 is formed around the through-hole 28 on a first surface 22a of the disk plate 22. The recess 24 is formed during a disk molding process for forming the disk plate 22, and the through-hole 28 is formed using a punching process after the disk plate 22 is manufactured.

The hub 10 explained with reference to FIGS. 1 and 2 is inserted into the through-hole 28 of the optical disk 20. The depth of the recess 24 is equal to the thickness of the upper hub 12 of the hub 10, and the radial length of the recess 24 is equal to the difference ΔR between the radial lengths of the upper hub 12 and the lower hub 16. Accordingly, when the hub 10 is inserted into the through-hole 28, the upper hub 12 of the hub 10 is mounted in the recess 24 formed on the first surface 22a of the disk plate 22. A top surface of the upper hub 12 is almost aligned with the first surface 22a of the disk plate 22.

A recording layer 32 and a protective layer 34 may be formed on a second surface 22b of the disk plate 22 opposite to the first surface 22a of the disk plate 22. While the recording layer 32 and the protective layer 34 are formed on the second surface 22b in the present embodiment, the present invention is not limited thereto, and the recording layer 32 and the protective layer 34 may be formed on the first surface 22a as well. The position of the recording layer 32 can be varied according to the size and storage capacity of the information storage device. The recording layer 32 may be formed at a distance of approximately 0.5 to 3.0 mm from an outermost edge of the disk plate 22 to have a predetermined width in a radial direction of the disk plate 22.

The hub 10 and the disk plate 22 may be coupled to each other using an epoxy resin 40. The diameter of the through-hole 28 formed in the disk plate 22 is almost equal to the outer diameter of the lower hub 16. The total thickness Dₜ of the hub 10 is equal to the sum of the thickness of the disk plate 22 and the thickness of the protective layer 34. Accordingly, when the hub 10 is inserted into the through-hole 28 of the disk plate 22, the hub 10 does not protrude outwardly from the first surface 22a and the second surface 22b of the disk plate 22.

Evaluation

The corrosion resistance characteristics of a hub according to an embodiment of the present invention were evaluated as follows.

First, after ferrite powder as a magnetic metal and polycarbonate powder as a polymer were mixed at a volume ratio of 1:1 and then injected into a shape as shown in FIG. 1, a heat cycle test was performed to find corrosion.

Chamber conditions used in the heat cycle test were based on storage medium heat cycle test requirements specified in the DVD standard.

The detailed conditions for the heat cycle test used to evaluate the corrosion resistance characteristics of the hub of the present embodiment are shown in Table 1.

TABLE 1

| | DVD standard | Test conditions |
|---|---|---|
| High temperature | 40 ± 2° C. | 80 ± 2° C. |
| Relative humidity | 90% | 95˜100% |
| Low temperature | 25 ± 3° C. | 15 ± 2° C. |
| Cycle time | 12 hours + 12 hours | 12 hours + 12 hours |
| Number of cycles | 6 | 6 |

It can be seen that no corrosion was found in the evaluated hub. When compared with a conventional metal hub, the evaluated hub showed similar chucking characteristics. Accordingly, the hub made of the magnetic metal-polymer composite material according to the present embodiment has characteristics suitable for a small form factor optical disk.

As described above, the hub is made of the metal-polymer composite material and the optical disk includes the hub. The hub can be simply manufactured using a typical resin injection process, and offer chucking characteristics similar to those of a metal hub. Since the hub of the present embodiment is made of the metal-polymer composite material not to be affected by corrosion, costs for manufacturing the small form factor optical disk can be reduced. Also, since the hub attached to the disk plate has almost the same thickness as the thickness of the disk plate not to protrude from the disk plate, the total thickness of the optical disk can be reduced.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A hub for an optical disk, the hub being made of a magnetic metal-polymer composite material.

2. The hub of claim 1, wherein the magnetic metal-polymer composite material is formed by mixing the magnetic metal with the polymer at a ratio of 3:7 to 5:5.

3. The hub of claim 1, wherein the magnetic metal is an iron-based soft magnetic material or nickel.

4. The hub of claim 1, wherein the polymer is a curable resin.

5. The hub of claim 1, comprising:
a disk-shaped upper hub having a first radial length; and
a lower hub integrally extending from the upper hub and having a second radial length less than the first radial length,
wherein a central hole passes through both the upper hub and the lower hub.

6. An optical disk including a hub, the optical disk comprising:
a disk plate having a central through-hole and a recess, lower than an edge, formed around the through-hole; and
a hub made of a magnetic metal-polymer composite material and inserted into the through-hole to be coupled to the disk plate.

7. The optical disk of claim 6, wherein the hub comprises:
a disk-shaped upper hub having a first radial length;
a lower hub integrally extending from the upper hub and having a second radial length less than the first radial length, with a central hole passing through both the upper hub and the lower hub,
wherein, when the hub is inserted into the through-hole of the disk plate to be coupled to the disk plate, the upper hub is mounted in the recess.

8. The optical disk of claim 7, wherein, when the hub is coupled to the disk, a top surface of the upper hub and a first surface of the disk are aligned.

9. The optical disk of claim 6, further comprising a protective layer covering a second surface of the disk plate opposite to the first surface of the disk plate,
wherein the total thickness of the hub is equal to the sum of the thickness of the disk plate and the thickness of the protective layer.

10. The optical disk of claim 6, wherein the hub is made of a composite material composed of a soft magnetic material and a curable resin.
